(19) United States
(12) Patent Application Publication
(10) Pub. No.: US 2004/0060186 A1
(43) Pub. Date: Apr. 1, 2004

(54) Laser alignment tool

(75) Inventor: Michael H. Peine, Maple Grove, MN (US)

Correspondence Address: DICKE, BILLIG & CZAJA, 701 Building, Suite 1250, 701 Fourth Avenue South, Minneapolis, MN, 55415, US

(73) Assignee: August Technology Corp.

(21) Appl. No.: 10/262,478

(22) Filed: Sep. 30, 2002

(51) Int. Cl. G01D 21/00

(52) U.S. Cl. 33/645

(57) ABSTRACT

A laser alignment tool for properly aligning the laser used to count, differentiate, measure, determine orientation or if cross slotted, and/or otherwise correlate or verify position, quantity or other parameters of wafers or like substrates in a cassette.

### BACKGROUND OF THE INVENTION

1. Technical Field

The present invention relates to substrate handling systems for the semiconductor industry such as those used in conjunction with defect inspection systems. More particularly, the present invention is a laser alignment tool for properly aligning the laser used to count, differentiate, measure, determine orientation or if cross slotted, and/or otherwise correlate or verify position, quantity or other parameters of wafers or like substrates in a cassette.

2. Background Information

Over the past several decades, the semiconductor has exponentially grown in use and popularity. The semiconductor has in effect revolutionized society by introducing computers, electronic advances, and generally revolutionizing many previously difficult, expensive and/or time consuming mechanical processes into simplistic and quick electronic processes. This boom in semiconductors has been fueled by an insatiable desire by business and individuals for computers and electronics, and more particularly, faster, more advanced computers and electronics whether it be on an assembly line, on test equipment in a lab, on the personal computer at one's desk, or in the home electronics and toys.

The manufacturers of semiconductors have made vast improvements in end product quality, speed and performance as well as in manufacturing process quality, speed and performance. However, there continues to be demand for faster, more reliable and higher performing semiconductors.

One process that has evolved over the past decade or so is the semiconductor inspection process. The merit in inspecting semiconductors throughout the manufacturing process is obvious in that bad wafers may be removed at the various steps rather than processed to completion only to find out a defect exists either by end inspection or by failure during use.

It is necessary to provide wafers to the inspection system, or other systems or processes in the manufacture, inspection, packaging, etc. of wafers. Lasers are often used for a variety of tasks including counting the number of wafers in a cassette, determining or verifying the presence of a wafer in a particular position in a cassette, determining the location of a wafer, differentiating wafers from each other, measuring wafers, determining if wafers are cross slotted or otherwise misaligned, and many others as are well known in the electronics and semiconductor manufacturing industry. It is critical that the laser be properly aligned or else the above described calculations may occur improperly, inaccurately or not at all. No tool currently exists to successfully align the laser.

### SUMMARY OF THE INVENTION

The present invention is a laser alignment tool for properly aligning the laser used to count, differentiate, measure, determine orientation or if cross slotted, and/or otherwise correlate or verify position, quantity or other parameters of wafers or like substrates in a cassette.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a perspective drawing of the laser alignment tool of the present invention;

FIG. 2 is a top view of the laser alignment tool of FIG. 1;

FIG. 3 is a side view of the laser alignment tool of FIG. 1;

FIG. 4 is a left end view of the laser alignment tool of FIG. 1;

FIG. 5 is a right end view of the laser alignment tool of FIG. 1;

FIG. 6 is a digital image of the laser alignment tool of FIG. 1 positioned in front of a wafer loaded into a cassette;

FIG. 7 is an enlarged digital image of the laser alignment tool as shown in FIG. 6; and

FIG. 8 is a digital image of the laser alignment tool of FIGS. 1-7.

Similar numerals refer to similar parts throughout the drawings.

### DETAILED DESCRIPTION OF THE PREFERRED EMBODIMENT

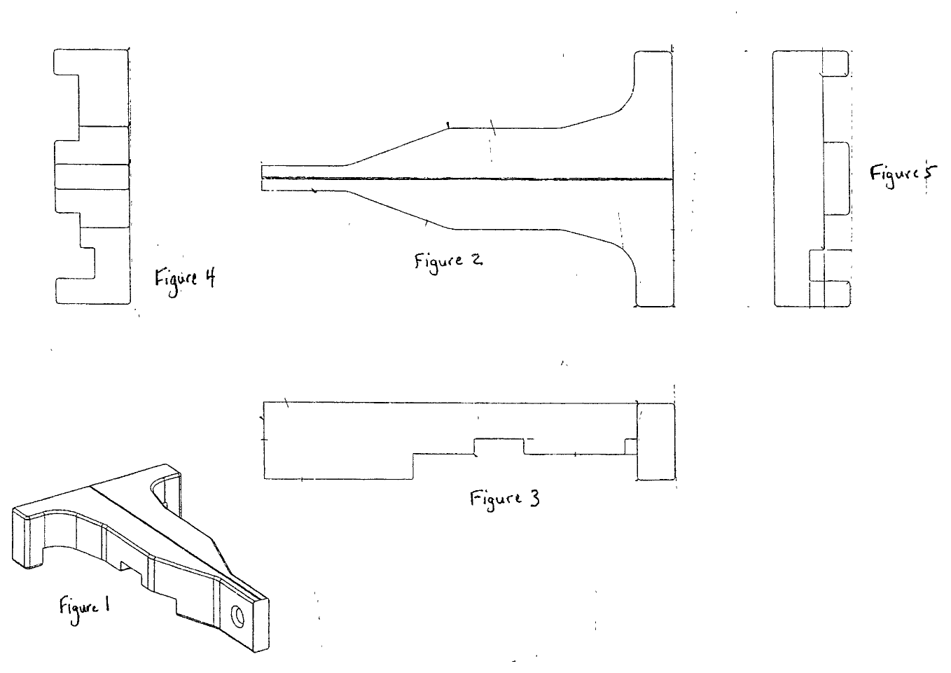

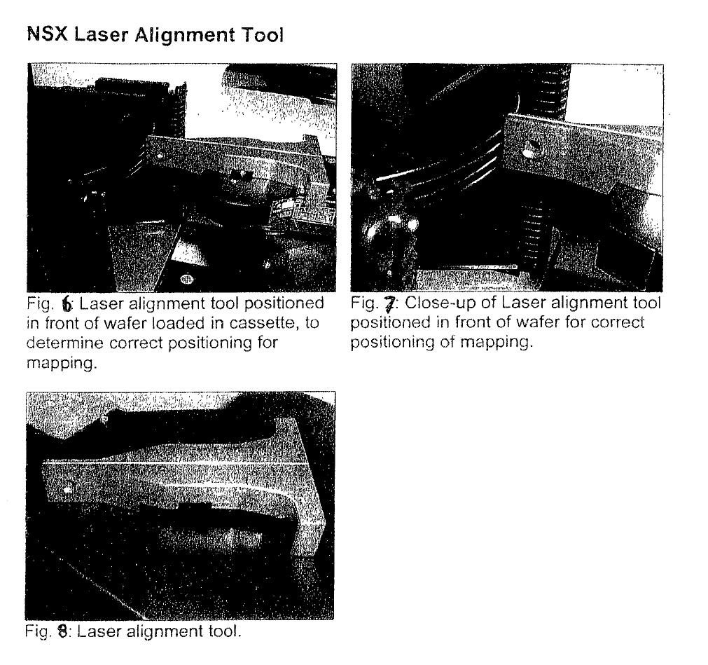

The laser alignment tool of the present invention is indicated generally at 10 as is best shown overall in FIGS. 1 and 8, and is used in one environment as shown in FIGS. 6-7. The laser alignment tool 10 is designed and constructed to sit on top of the laser arm or housing 20 with a laser 22 attached thereto such as is shown in FIGS. 6 and 7. Once the laser alignment tool 10 is positioned on top of the laser arm or housing 20, it provides for exact alignment and proper spacing of the laser 22 from the wafers positioned in a cassette.

The laser 22 may be used in conjunction with wafer or substrate handling, manufacture, inspection, etc. whereby the laser is used for any of a number of processes including to count, differentiate, measure, determine orientation or if cross slotted, and/or otherwise correlate or verify position, quantity or other parameters of wafers or like substrates in a cassette. In the environment shown, the laser 22 is used to count wafers within a cassette, determine if a wafer is located within a given slot, and determine if a wafer is entirely in its slot or improperly cross slotted (that is one side of the wafer is in one slot while the other side is in the slot above or below). Where the laser alignment tool 10 is used, the laser is precisely aligned and properly spaced thereby significantly improving the likelihood that the laser will properly read the position, location or presence of a wafer.

The laser alignment tool 10 is an elongated body having a top surface 30, a bottom surface 32, and a plurality of side surfaces therebetween including end surface 34. The top surface 30 is generally planar and includes a laser line 36 that functions as a center line for indicating and/or accentuating the alignment of the laser beam with the center of the wafers.

The bottom surface 32 includes a spacing section 40 that is defined by a stop face 42 and the end surface 34. The spacing section is used to properly space the laser arm or housing 20 with the laser 22 securely attached thereto by setting the gap between the laser arm or housing 20 and the wafers. This is accomplished by gently moving the laser arm or housing 20 with the tool 10 thereon toward the wafers in a properly positioned cassette until the end surface 34 touches the wafers whereby the gap or distance is properly set as the end surface 34 and stop face 42 prevent further convergence. The result is proper spacing as the spacing section is sandwiched between the wafers and the arm or housing.

The stop face is designed to lock or securely seat against an end lip or face 46 of the laser arm or housing as is shown in the Figures. The bottom surface 32 further includes a recessed portion 50 that snuggly seats on top of the laser arm or housing such that the stop face 42 locks over the end lip 46 while extensions snuggly wrap around or otherwise interact with the arm or housing 20 to properly position and hold the laser alignment tool 10 in place on the arm or housing 20. The extensions in the embodiment shown include 52 and 54 which extend outward from the housing 20 and terminate in a locking nub 60 as is shown in the Figures. This locking nub securely snaps or locks around the arm or housing 20. The recess 50 may also include notches or other voids for parts extending from the laser arm or housing 20 such as screws, fasteners, LEDs, etc.

In use, the laser alignment tool 10 allows the computer and robotics to be trained as to the precise desired position. Basically, the servo motors or like actuators are disengaged or turned off, the laser arm or housing is then manually moved into the precisely desired position which is easily found as the laser alignment tool 10 sits on top of the arm and readily indicates the exact desired position. Once the precise position is found, the system is trained to repetitively return to this exact position during operation.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

What is claimed is:

1. An alignment tool comprising a body having a recess that allows for a snug fit over a housing to be aligned, and an end face for engagement with wafers where the end face is properly distanced to assure proper distancing of the wafers from the housing to be aligned.
